(19) United States
(12) Patent Application Publication
(10) Pub. No.: US 2024/0249567 A1
(43) Pub. Date: Jul. 25, 2024

(54) SYSTEMS AND METHODS FOR VEHICLE FAULT DETECTION AND IDENTIFICATION USING AUDIO ANALYSIS

(71) Applicant: Honeywell International Inc., Charlotte, NC (US)

(72) Inventor: Fabian CONSTANTINO, Phoenix, AZ (US)

(21) Appl. No.: 18/156,860

(22) Filed: Jan. 19, 2023

(51) Int. Cl. G07C 5/08; B64F 5/60; G01S 5/20

(52) U.S. Cl. CPC G07C 5/0808; B64F 5/60; G01S 5/20; G07C 5/0833; G07C 5/085; G10L 25/51

(57) ABSTRACT

A method for automatically determining a fault of a vehicle comprises receiving one or more audio signals from one or more microphones of the vehicle; extracting diagnostic metadata from the received one or more audio signals; extracting a diagnostic feature from the diagnostic metadata, the extracted diagnostic feature corresponding to a feature of a trained machine-learning based model for determining a fault based on a learned association between the extracted diagnostic feature and a fault of the vehicle; and automatically determining the fault based on the extracted diagnostic feature, by using the trained machine-learning based model that was trained based on a first feature extracted from first training metadata regarding previously recorded data and a second feature extracted from metadata regarding a previous fault related to the previously recorded data, based on the learned association between the extracted diagnostic feature and the fault.

### TECHNICAL FIELD

Various embodiments of the present disclosure relate generally to systems and methods for detecting and identifying a fault of a vehicle based on an audio signal, and, more particularly, to systems and methods for using artificial intelligence to analyze an audio signal to detect and identify a fault of a vehicle.

### BACKGROUND

A fault may occur on a vehicle, such as a motor vehicle or an aircraft, for example, which provides no indication to the operator of the cause of the fault. The fault may be accompanied by a sudden and irreproducible sound. This sound may provide useful information for diagnosing and addressing the issue. However, without experienced personnel, such as a maintenance crew, for example, in the vehicle at the time that the sound is produced by the vehicle, the issue may be difficult to diagnose.

The present disclosure is directed to overcoming one or more of these above-referenced challenges.

### SUMMARY OF THE DISCLOSURE

In some aspects, the techniques described herein relate to a method for automatically determining a fault of a vehicle, the method including: receiving one or more audio signals from one or more microphones of the vehicle; extracting diagnostic metadata from the received one or more audio signals; extracting a diagnostic feature from the diagnostic metadata, the extracted diagnostic feature corresponding to a feature of a trained machine-learning based model for determining a fault based on a learned association between the extracted diagnostic feature and a fault of the vehicle; and automatically determining the fault based on the extracted diagnostic feature, by using the trained machine-learning based model that was trained based on a first feature extracted from first training metadata regarding previously recorded data and a second feature extracted from metadata regarding a previous fault related to the previously recorded data, based on the learned association between the extracted diagnostic feature and the fault.

In some aspects, the techniques described herein relate to a method, further including: receiving an input signal from a user input of the vehicle to create a timestamp for the received one or more audio signals; and triangulating a location of a source of the received one or more audio signals using the timestamp and the received one or more audio signals.

In some aspects, the techniques described herein relate to a method, further including: storing the received one or more audio signals and the timestamp.

In some aspects, the techniques described herein relate to a method, further including: storing vehicle data associated with the received one or more audio signals and the timestamp.

In some aspects, the techniques described herein relate to a method, wherein the vehicle is an aircraft, the one or more microphones of the vehicle includes a headset in a cockpit of the aircraft, and the vehicle data is avionics data.

In some aspects, the techniques described herein relate to a method, wherein: the one or more microphones includes a first microphone and a second microphone, the one or more audio signals includes a first audio signal from the first microphone and a second audio signal from the second microphone, and the triangulating the location of the source includes using the first audio signal and the second audio signal.

In some aspects, the techniques described herein relate to a method, wherein the extracting the diagnostic metadata from the received one or more audio signals includes using natural language processing.

In some aspects, the techniques described herein relate to a method, further including: providing an alert to an operator of the vehicle based on the determined fault.

In some aspects, the techniques described herein relate to a method, wherein the extracting the diagnostic metadata from the received one or more audio signals includes reducing constant noise patterns in the received one or more audio signals using an active noise cancellation filter.

In some aspects, the techniques described herein relate to a method, further including: temporarily storing a rolling predetermined amount of the received one or more audio signals.

In some aspects, the techniques described herein relate to a system for automatically determining a fault of a vehicle, the system including: one or more processors configured to perform operations including: receiving one or more audio signals from one or more microphones of the vehicle; extracting diagnostic metadata from the received one or more audio signals; extracting a diagnostic feature from the diagnostic metadata, the extracted diagnostic feature corresponding to a feature of a trained machine-learning based model for determining a fault based on a learned association between the extracted diagnostic feature and a fault of the vehicle; and automatically determining the fault based on the extracted diagnostic feature, by using the trained machine-learning based model that was trained based on a first feature extracted from first training metadata regarding previously recorded data and a second feature extracted from metadata regarding a previous fault related to the previously recorded data, based on the learned association between the extracted diagnostic feature and the fault.

In some aspects, the techniques described herein relate to a system, wherein the operations further include: receiving an input signal from a user input of the vehicle to create a timestamp for the received one or more audio signals; and triangulating a location of a source of the received one or more audio signals using the timestamp and the received one or more audio signals.

In some aspects, the techniques described herein relate to a system, wherein the operations further include: storing the received one or more audio signals and the timestamp.

In some aspects, the techniques described herein relate to a system, wherein the operations further include: storing vehicle data associated with the received one or more audio signals and the timestamp.

In some aspects, the techniques described herein relate to a system, wherein the vehicle is an aircraft, the one or more microphones of the vehicle includes a headset in a cockpit of the aircraft, and the vehicle data is avionics data.

In some aspects, the techniques described herein relate to a system, wherein: the one or more microphones includes a first microphone and a second microphone, the one or more audio signals includes a first audio signal from the first microphone and a second audio signal from the second microphone, and the triangulating the location of the source includes using the first audio signal and the second audio signal.

In some aspects, the techniques described herein relate to a system, wherein the extracting the diagnostic metadata from the received one or more audio signals includes using natural language processing.

In some aspects, the techniques described herein relate to a system, wherein the operations further include: providing an alert to an operator of the vehicle based on the determined fault.

In some aspects, the techniques described herein relate to a system, wherein the extracting the diagnostic metadata from the received one or more audio signals includes reducing constant noise patterns in the received one or more audio signals using an active noise cancellation filter.

In some aspects, the techniques described herein relate to a non-transitory computer-readable medium storing instructions that, when executed by one or more processors, cause the one or more processors to perform operations for automatically determining a fault of a vehicle, the operations including: receiving one or more audio signals from one or more microphones of the vehicle; extracting diagnostic metadata from the received one or more audio signals; extracting a diagnostic feature from the diagnostic metadata, the extracted diagnostic feature corresponding to a feature of a trained machine-learning based model for determining a fault based on a learned association between the extracted diagnostic feature and a fault of the vehicle;

and automatically determining the fault based on the extracted diagnostic feature, by using the trained machine-learning based model that was trained based on a first feature extracted from first training metadata regarding previously recorded data and a second feature extracted from metadata regarding a previous fault related to the previously recorded data, based on the learned association between the extracted diagnostic feature and the fault.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a system for using artificial intelligence to analyze an audio signal to detect and identify a fault of a vehicle, according to one or more embodiments.

FIG. 2 depicts a flowchart of a method of using artificial intelligence to analyze an audio signal to detect and identify a fault of a vehicle, according to one or more embodiments.

FIG. 3 depicts an exemplary implementation of a controller that may execute techniques presented herein, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value. In this disclosure, unless stated otherwise, “automatically” is used to indicate that an operation is performed without user input or intervention.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to systems and methods for detecting and identifying a fault of a vehicle based on an audio signal, and, more particularly, to systems and methods for using artificial intelligence to analyze an audio signal to detect and identify a fault of a vehicle.

A fault may occur on a vehicle, such as a motor vehicle or an aircraft, for example, which provides no indication to the operator of the cause of the fault. The fault may be accompanied by a sudden and irreproducible sound. This sound may provide useful information for diagnosing and addressing the issue. However, without experienced personnel, such as a maintenance crew, for example, in the vehicle at the time that the sound is produced by the vehicle, the issue may be difficult to diagnose. For example, an aircraft mechanic may have to rely on a pilot's memory and documentation to recall an erroneous sound, and may have to painstakingly troubleshoot the vehicle to find the source of the fault.

One or more embodiments may provide a system that uses artificial intelligence to quickly recognize a fault based on an audio signal, which may more effectively detect, identify, diagnose, or resolve a fault of a vehicle. One or more embodiments may provide a system for maintenance personnel to more quickly address, identify, and resolve a fault, such as a mechanical issue, for example, on a vehicle. One or more embodiments may provide a system that improves operator awareness of a severity and cause of an erroneous sound from the vehicle during an operation of the vehicle. One or more embodiments may provide a system that addresses a difficulty in diagnosing a fault that causes a noise that can be heard by an operator of the vehicle, such as in a cockpit of an aircraft, for example, but otherwise does not have an effective method to identify or diagnose the fault.

One or more embodiments may identify, quantify, and locate a fault when the fault occurs. One or more embodiments may provide maintenance personnel with a better indication of a problem with the vehicle or may provide the exact problem, which may reduce vehicle downtime, maintenance time, and cost of operation. One or more embodiments may triangulate the source of the sound in the vehicle and provide an indication of the location of the source of the sound, which maintenance personnel may use to troubleshoot the fault.

One or more embodiments may collect data related to various audio recordings of a vehicle, including both during operation without a fault and during operation with a fault. The collected data may be used to train a machine learning system, such as a neural network, for example, to analyze the collected data, such as by performing sentiment analysis, for example. The system may use artificial intelligence techniques including natural language processing, for example. The trained machine learning system may identify and categorize the collected data related to the audio recordings, and identify a fault correlated with a given audio input.

The system may be implemented onboard the vehicle, and may use existing hardware of the vehicle, such as a pilot headset and/or microphone, or an audio system of a motor vehicle, for example, to monitor sounds of the vehicle during an operation of the vehicle. Upon detecting an audio input correlated with a fault, the system may provide an alert to the operator that identifies the detected fault. Upon detecting an audio input correlated with a fault, the system may record pertinent data, such as the audio signal, a status of the vehicle, and the detected fault, for example, for use by maintenance personnel to resolve the fault of a vehicle.

One or more embodiments may use at least one audio input, such as from a microphone in a headset for a pilot, for example, and may use multiple audio inputs. Using an open audio feed from each microphone, the audio data may be processed by an active noise cancellation filter to reduce constant noise patterns, such as normally operating engine sounds and wind, for example. The system may temporarily store a rolling predetermined amount of audio data, such as audio data for the past two minutes, for example.

When a fault occurs, an operator of the vehicle may log the fault, such as by pressing a button on the vehicle, for example. This log action may trigger the system to store the temporary audio data, so that the temporary audio data is not overwritten, which may be used by maintenance personnel. By algorithmically using the sound of the fault that was picked up in each microphone in the vehicle, the system may triangulate the source of the sound in the vehicle and provide an indication of the location of the source of the sound, which maintenance personnel may use to troubleshoot the fault.

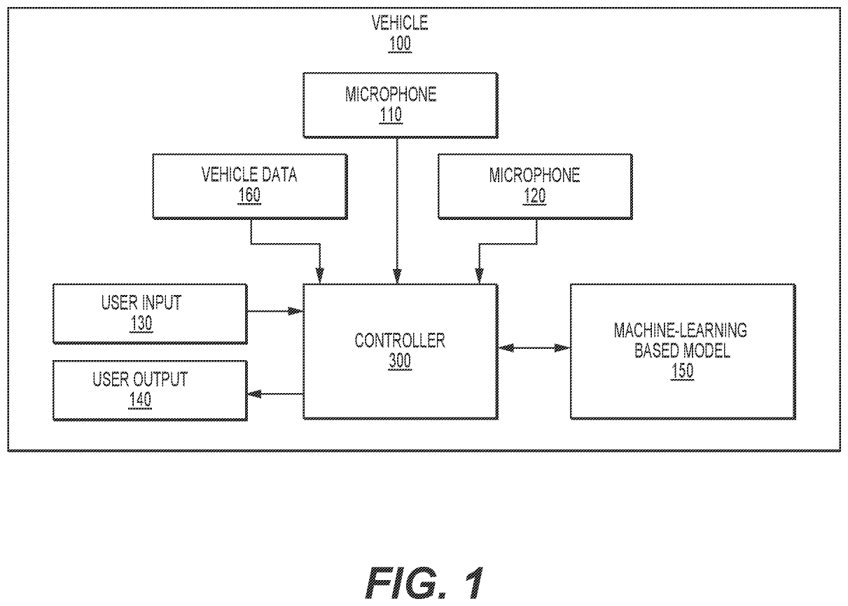

FIG. 1 depicts an exemplary system infrastructure for a system for using artificial intelligence to analyze an audio signal to detect and identify a fault of a vehicle, according to one or more embodiments. Vehicle 100 may include a first microphone 110, a second microphone 120, a user input 130, a user output 140, a trained machine-learning based model 150, vehicle data 160, and controller 300.

Vehicle 100 may be a motor vehicle, an aircraft, or a watercraft, for example. First microphone 110 and second microphone 120 may be transducers for converting sound waves into an electrical signal. For example, first microphone 110 and second microphone 120 may include one or more of a microphone in a headset of a pilot of an aircraft, or a speaker, used as a microphone, in a motor vehicle. First microphone 110 and second microphone 120 may each include one or more microphones.

User input 130 may include an input device for a user to provide an input signal to controller 300. User input 130 may include one or more of a physical button, a virtual button on a touch screen, a microphone for receiving voice commands, or any other device operative to interact with the controller 300. User output 140 may include an output device for a user to receive an output signal from controller 300. For example, user output 140 may include one or more of an indicator light, a speaker, a buzzer, a haptic feedback device, a display, a projector, a printer, or other now known or later developed device for outputting determined information.

Trained machine-learning based model 150 may be instructions 324 stored in a memory 304 of controller 300, or may be stored in another form in vehicle 100 and accessible by controller 300. The trained machine-learning based model 150 that may be useful and effective for the analysis is a neural network, which is a type of supervised machine learning. However, other machine learning techniques and frameworks may be used to perform the methods contemplated by the present disclosure. For example, the systems and methods may be realized using other types of supervised machine learning, such as regression problems or random forest, for example, using unsupervised machine learning such as cluster algorithms or principal component analysis, for example, and/or using reinforcement learning. The trained machine-learning based model 150 may alternatively or additionally be rule-based.

Vehicle data 160 may include information providing a status of the vehicle 100, such as a speed, location, altitude, or temperature, for example. The vehicle data 160 may be data from an avionics component of an aircraft, or data from a diagnostic controller in a motor vehicle, for example.

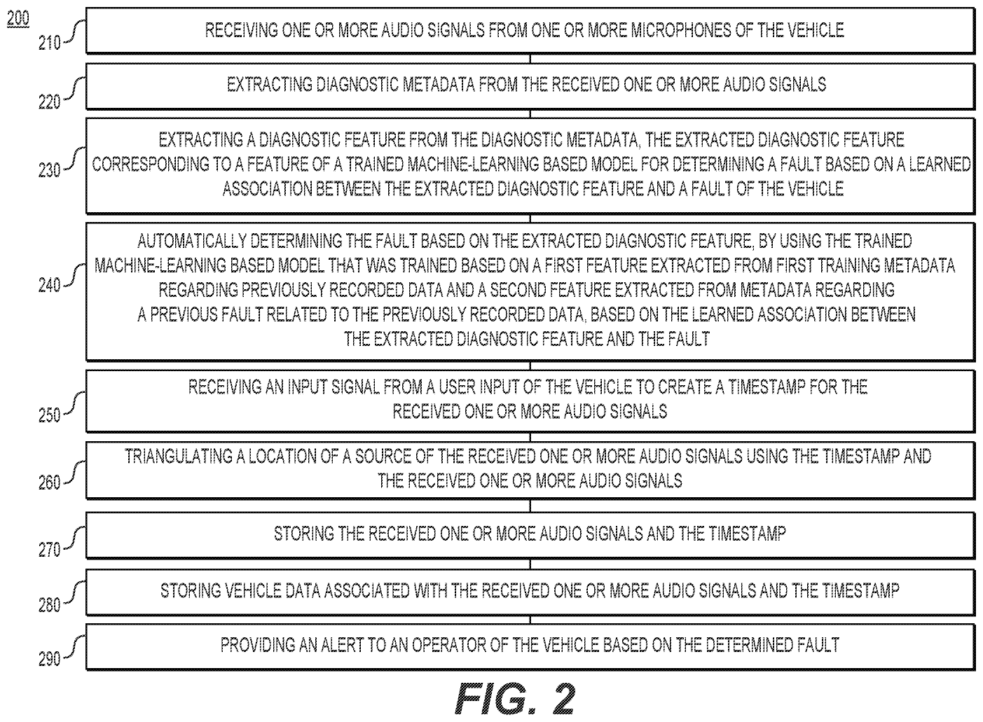

FIG. 2 depicts a flowchart of a method of using artificial intelligence to analyze an audio signal to detect and identify a fault of a vehicle, according to one or more embodiments. A method 200 for automatically determining a fault of a vehicle 100 may include various operations, which may be executed by controller 300, for example.

Method 200 may include receiving one or more audio signals from one or more microphones (e.g. first microphone 110 and/or second microphone 120) of the vehicle 100 (operation 210). One or more of the first microphone 110 or second microphone 120 may receive a sound signal from an environment of the vehicle 100, such as in a cockpit of an aircraft, for example. The sound signal may include normal sounds of the vehicle 100 in operation, such as engine noise, wind noise, landing gear operation, air conditioning system noise, auxiliary power unit noise, power transfer unit noise, servo noise, wing flap operation, and pilot communication, for example. The sound signal may include erroneous sounds of the vehicle 100 in operation, such as excess wind noise, brake pad squealing, engine knocking, and fault buzzers, for example.

Reception of the sound signal may be delayed to second microphone 120 relative to reception of the sound signal to first microphone 110 based on a location of first microphone 110 and second microphone 120. One or more of the first microphone 110 or second microphone 120 may convert the sound signal to an audio/electrical signal, and send the audio signal to the controller 300.

Method 200 may include extracting diagnostic metadata from the received one or more audio signals (operation 220). The extracting the diagnostic metadata from the received one or more audio signals may include using natural language processing. The extracting the diagnostic metadata from the received one or more audio signals may include reducing constant noise patterns in the received one or more audio signals using an active noise cancellation filter. For example, the controller 300 may use an active noise cancellation filter to reduce or remove signal patterns correlated with the normal sounds of the vehicle 100 in operation.

The controller may also use vehicle data 160 to reduce or remove signal patterns correlated with the normal sounds of the vehicle 100 in operation. For example, a sound from landing gear may be expected during landing procedure, and may be filtered as a normal sound. However, the same sound from landing gear during a cruising procedure in the aircraft may be unexpected, and may not be filtered as a normal sound (i.e. the landing gear noise may be identified as an erroneous sound associated with a fault).

Controller 300 may further process the noise-filtered signal to extract diagnostic metadata, such as a signal pattern having characteristics such as amplitude, period, frequency, or a phase, for example. The noise-filtered signal may be an analog signal or a digital signal, and the diagnostic metadata may include a timestamp of the signal, one or more characteristics of the signal, or other data to identify the signal.

Method 200 may include extracting a diagnostic feature from the diagnostic metadata, the extracted diagnostic feature corresponding to a feature of a trained machine-learning based model 150 for determining a fault based on a learned association between the extracted diagnostic feature and a fault of the vehicle 100 (operation 230). For example, controller 300 may extract a diagnostic feature such as a frequency of the signal from the diagnostic metadata. Controller 300 may provide the extracted diagnostic feature as an input to trained machine-learning based model 150.

Method 200 may include automatically determining the fault based on the extracted diagnostic feature, by using the trained machine-learning based model 150 that was trained based on a first feature extracted from first training metadata regarding previously recorded data and a second feature extracted from metadata regarding a previous fault related to the previously recorded data, based on the learned association between the extracted diagnostic feature and the fault (operation 240).

For example, trained machine-learning based model 150 may be trained to recognize that a signal in a threshold frequency range may be associated with a faulty fan in an air conditioning system of an aircraft. Accordingly, the trained machine-learning based model 150 may receive the extracted diagnostic feature (e.g. signal frequency) as an input, determine the fault (e.g. faulty fan) based on the received diagnostic feature, and return the fault as an output to controller 300.

Method 200 may include receiving an input signal from a user input 130 of the vehicle 100 to create a timestamp for the received one or more audio signals (operation 250). For example, an operator of vehicle 100 may hear an unknown sound during an operation of the vehicle, and may provide an input signal using user input 130 (e.g. by pressing a button in vehicle 100) to controller 300 to create a timestamp to mark the time that the operator heard the unknown sound.

Method 200 may include triangulating a location of a source of the received one or more audio signals using the timestamp and the received one or more audio signals (operation 260). The one or more microphones may include a first microphone 110 and a second microphone 120. The one or more audio signals may include a first audio signal from the first microphone 110 and a second audio signal from the second microphone 120. The triangulating the location of the source may include using the first audio signal and the second audio signal. For example, controller 300 may use a known location and geometry of first microphone 110 and second microphone 120, and a difference between the sound signal received by second microphone 120 and the sound signal received by first microphone 110 to triangulate the location of the source of the sound.

For example, controller 300 may compare the sound signal received by second microphone 120 and the sound signal received by first microphone 110, and determine a location of the source of the sound to a position with a forty-degree elevation angle and a ten-degree angle relative to a reference point and central axis in a cockpit of an aircraft. Accordingly, maintenance personnel may use the triangulated location to determine the source of the sound and the fault. Alternatively or additionally, controller 300 may use the triangulated location along with a known location and geometry of components of vehicle 100 to determine the source of the sound and the fault.

Method 200 may include storing, such as in memory 304, for example, the received one or more audio signals and the timestamp (operation 270). Method 200 may include storing vehicle data 160 associated with the received one or more audio signals and the timestamp (operation 280). For example, controller 300 may store the received one or more audio signals and/or the extracted diagnostic metadata along with the timestamp of when the user input was received, thereby providing a general timestamp of when the sound was heard. The vehicle data may include information providing a status of the vehicle, such as a speed, location, altitude, or temperature, for example. Controller 300 may also store additional data correlated with the sound, such as the triangulated location, extracted diagnostic feature, or the determined fault, for example.

As an example, the vehicle 100 may be an aircraft, the one or more microphones of the vehicle 100 may include a headset in a cockpit of the aircraft, and the vehicle data may include avionics data. Method 200 may include providing an alert to a user output 140 for an operator of the vehicle 100 based on the determined fault (operation 290). For example, an alert may include one or more of an audio or visual indication. Controller 300 may provide a textual fault indication to a heads-up display in a motor vehicle, or sound a warning buzzer in an aircraft with a specified tone or period, depending on the determined fault. Method 200 may include temporarily storing a rolling predetermined amount of the received one or more audio signals. For example, controller 300 may store two minutes, for example, of received audio data, and may overwrite the stored data on a rolling basis if no fault is detected.

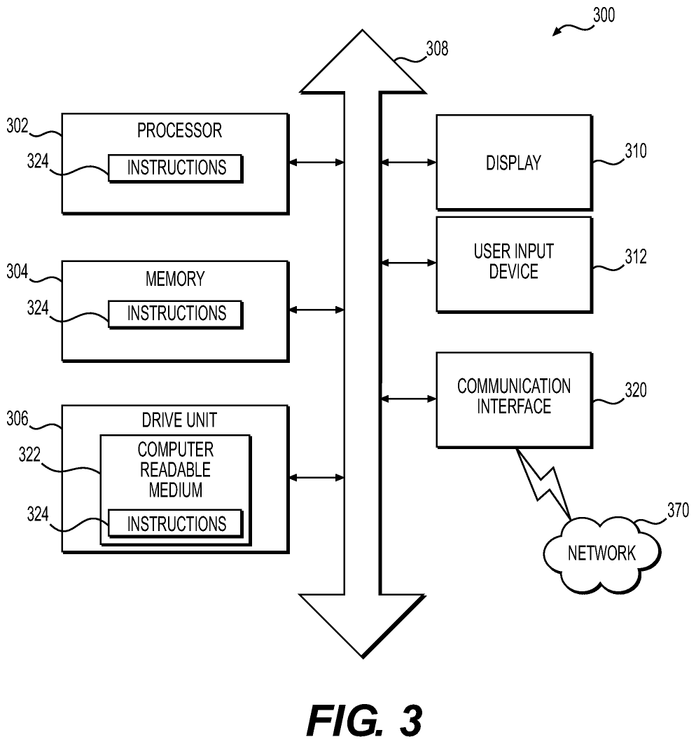

FIG. 3 depicts an implementation of a controller 300 that may execute techniques presented herein, according to one or more embodiments. The controller 300 may include a set of instructions that can be executed to cause the controller 300 to perform any one or more of the methods or computer based functions disclosed herein.

The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As illustrated in FIG. 3, the controller 300 may include a processor 302, e.g., a central processing unit (CPU), a graphics processing unit (GPU), or both. The processor 302 may be a component in a variety of systems. For example, the processor 302 may be part of a standard computer. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the controller 300 may include an input device 312 configured to allow a user to interact with any of the components of controller 300.

The input device 312 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 322 in which one or more sets of instructions 324, e.g. software, can be embedded. Further, the instructions 324 may embody one or more of the methods or logic as described herein. The instructions 324 may reside completely or partially within the memory 304 and/or within the processor 302 during execution by the controller 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication port or interface 320, and/or using a bus 308. The communication port or interface 320 may be a part of the processor 302 or may be a separate component. The communication port or interface 320 may be created in software or may be a physical connection in hardware. The communication port or interface 320 may be configured to connect with a network 370, external media, the display 310, or any other components in controller 300, or combinations thereof. The connection with the network 370 may be a physical connection, such as a wired Ethernet connection or may be established wirelessly as discussed below. Likewise, the additional connections with other components of the controller 300 may be physical connections or may be established wirelessly. The network 370 may alternatively be directly connected to a bus 308.

While the computer-readable medium 322 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 322 may be non-transitory, and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

One or more embodiments may provide a system that uses artificial intelligence to quickly recognize a fault based on an audio signal, which may more effectively detect, identify, diagnose, or resolve a fault of a vehicle. One or more embodiments may provide a system for maintenance personnel to more quickly address, identify, and resolve a fault, such as a mechanical issue, for example, on a vehicle. One or more embodiments may provide a system that improves operator awareness of a severity and cause of an erroneous sound from the vehicle during an operation of the vehicle. One or more embodiments may provide a system that addresses a difficulty in diagnosing a fault that causes a noise that can be heard by an operator of the vehicle, such as in a cockpit of an aircraft, for example, but otherwise does not have an effective method to identify or diagnose the fault. One or more embodiments may identify, quantify, and locate a fault when the fault occurs. One or more embodiments may provide maintenance personnel with a better indication of a problem with the vehicle or may provide the exact problem, which may reduce vehicle downtime, maintenance time, and cost of operation. One or more embodiments may triangulate the source of the sound in the vehicle and provide an indication of the location of the source of the sound, which maintenance personnel may use to troubleshoot the fault.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for automatically determining a fault of a vehicle, the method comprising:
receiving one or more audio signals from one or more microphones of the vehicle;
extracting diagnostic metadata from the received one or more audio signals;
extracting a diagnostic feature from the diagnostic metadata, the extracted diagnostic feature corresponding to a feature of a trained machine-learning based model for determining a fault based on a learned association between the extracted diagnostic feature and a fault of the vehicle; and
automatically determining the fault based on the extracted diagnostic feature, by using the trained machine-learning based model that was trained based on a first feature extracted from first training metadata regarding previously recorded data and a second feature extracted from metadata regarding a previous fault related to the previously recorded data, based on the learned association between the extracted diagnostic feature and the fault.

2. The method of claim 1, further comprising:
receiving an input signal from a user input of the vehicle to create a timestamp for the received one or more audio signals; and
triangulating a location of a source of the received one or more audio signals using the timestamp and the received one or more audio signals.

3. The method of claim 2, further comprising:
storing the received one or more audio signals and the timestamp.

4. The method of claim 3, further comprising:
storing vehicle data associated with the received one or more audio signals and the timestamp.

5. The method of claim 4, wherein the vehicle is an aircraft, the one or more microphones of the vehicle includes a headset in a cockpit of the aircraft, and the vehicle data is avionics data.

6. The method of claim 2, wherein:
the one or more microphones includes a first microphone and a second microphone,
the one or more audio signals includes a first audio signal from the first microphone and a second audio signal from the second microphone, and
the triangulating the location of the source includes using the first audio signal and the second audio signal.

7. The method of claim 1, wherein the extracting the diagnostic metadata from the received one or more audio signals includes using natural language processing.

8. The method of claim 1, further comprising:
providing an alert to an operator of the vehicle based on the determined fault.

9. The method of claim 1, wherein the extracting the diagnostic metadata from the received one or more audio signals includes reducing constant noise patterns in the received one or more audio signals using an active noise cancellation filter.

10. The method of claim 1, further comprising:
temporarily storing a rolling predetermined amount of the received one or more audio signals.

11. A system for automatically determining a fault of a vehicle, the system comprising:
one or more processors configured to perform operations including:
receiving one or more audio signals from one or more microphones of the vehicle;
extracting diagnostic metadata from the received one or more audio signals;
extracting a diagnostic feature from the diagnostic metadata, the extracted diagnostic feature corresponding to a feature of a trained machine-learning based model for determining a fault based on a learned association between the extracted diagnostic feature and a fault of the vehicle; and
automatically determining the fault based on the extracted diagnostic feature, by using the trained machine-learning based model that was trained based on a first feature extracted from first training metadata regarding previously recorded data and a second feature extracted from metadata regarding a previous fault related to the previously recorded data, based on the learned association between the extracted diagnostic feature and the fault.

12. The system of claim 11, wherein the operations further comprise:
receiving an input signal from a user input of the vehicle to create a timestamp for the received one or more audio signals; and
triangulating a location of a source of the received one or more audio signals using the timestamp and the received one or more audio signals.

13. The system of claim 12, wherein the operations further comprise:
storing the received one or more audio signals and the timestamp.

14. The system of claim 13, wherein the operations further comprise:
storing vehicle data associated with the received one or more audio signals and the timestamp.

15. The system of claim 14, wherein the vehicle is an aircraft, the one or more microphones of the vehicle includes a headset in a cockpit of the aircraft, and the vehicle data is avionics data.

16. The system of claim 12, wherein:
the one or more microphones includes a first microphone and a second microphone,
the one or more audio signals includes a first audio signal from the first microphone and a second audio signal from the second microphone, and
the triangulating the location of the source includes using the first audio signal and the second audio signal.

17. The system of claim 11, wherein the extracting the diagnostic metadata from the received one or more audio signals includes using natural language processing.

18. The system of claim 11, wherein the operations further comprise:
providing an alert to an operator of the vehicle based on the determined fault.

19. The system of claim 11, wherein the extracting the diagnostic metadata from the received one or more audio signals includes reducing constant noise patterns in the received one or more audio signals using an active noise cancellation filter.

20. A non-transitory computer-readable medium storing instructions that, when executed by one or more processors, cause the one or more processors to perform operations for automatically determining a fault of a vehicle, the operations comprising:
receiving one or more audio signals from one or more microphones of the vehicle;
extracting diagnostic metadata from the received one or more audio signals;
extracting a diagnostic feature from the diagnostic metadata, the extracted diagnostic feature corresponding to a feature of a trained machine-learning based model for determining a fault based on a learned association between the extracted diagnostic feature and a fault of the vehicle; and
automatically determining the fault based on the extracted diagnostic feature, by using the trained machine-learning based model that was trained based on a first feature extracted from first training metadata regarding previously recorded data and a second feature extracted from metadata regarding a previous fault related to the previously recorded data, based on the learned association between the extracted diagnostic feature and the fault.
